(19) United States
(12) Patent Application Publication
(10) Pub. No.: US 2026/0194803 A1
(43) Pub. Date: Jul. 9, 2026

(54) PROJECTION SCREEN

(71) Applicant: Brilliant Art technology co., Ltd., Kaohsiung City (TW)

(72) Inventor: Shih-Heng HUNG, Kaohsiung City (TW)

(21) Appl. No.: 19/358,819

(22) Filed: Oct. 15, 2025

(30) Foreign Application Priority Data
Jan. 9, 2025 (TW) 114100921

(51) Int. Cl. G03B 21/602; B29D 11/00

(52) U.S. Cl. CPC G03B 21/602; B29D 11/00278

(57) ABSTRACT

A projection screen includes an optical structure layer, a reflection layer, and a light-shielding layer. The optical structure layer includes an image display portion and a scattering portion that are integrally connected. The reflection layer is disposed on the scattering portion opposite to the image display portion. The light-shielding layer is disposed on the reflection layer opposite to the scattering portion. A method for manufacturing the projection screen includes: forming the optical structure layer including the image display portion and the scattering portion that are integrally connected; and forming the reflection layer and the light-shielding layer. The reflection layer is disposed on the scattering portion opposite to the image display portion. The light-shielding layer is disposed on the reflection layer opposite to the image display portion.

### CROSS-REFERENCE TO RELATED APPLICATION

This application claims priority to Taiwanese Invention Patent Application No. 114100921, filed on January 9, 2025, the entire disclosure of which is incorporated by reference herein.

### FIELD

The disclosure relates to a screen, and more particularly to a projection screen and a method for manufacturing the same.

### BACKGROUND

Based on a focal length of a projector, a projection screen for the projector may mainly be categorized into a short-throw projection screen, a mid-to-long-throw projection screen, and a long-throw projection screen.

Referring to FIG. 1, a conventional projection screen 9 includes an image display layer 91, an adhesion layer 92, a supporting layer 93, a structure layer 94 having curved cylindrical structures, a reflective layer 95, and a light-shielding layer 96 that are sequentially arranged in such order. The image display layer 91, the adhesion layer 92, the supporting layer 93, and the structure layer 94 are light-transmissible.

However, the conventional projection screen may have certain problems. For example, the image display layer 91 is adhered to the supporting layer 93 through the adhesion layer 92, and the supporting layer 93 and the structure layer 94 are separately formed. When an external force (e.g., a stress that is produced when the conventional projection screen is rolled up) is applied, the image display layer 91 may peel away from the supporting layer 93, and the supporting layer 93 may peel away from the structure layer 94.

Thus, a projection screen that can resolve the aforesaid problems is required in the industry.

### SUMMARY

Therefore, an object of the disclosure is to provide a projection screen that can alleviate at least one of the drawbacks of the prior art.

According to a first aspect of the disclosure, the projection screen includes an optical structure layer, a reflection layer, and a light-shielding layer. The optical structure layer includes an image display portion and a scattering portion that are integrally connected. The reflection layer is disposed on said scattering portion opposite to said image display portion. The light-shielding layer is disposed on said reflection layer opposite to said scattering portion.

According to a second aspect of the disclosure, a method for manufacturing the projection screen includes: forming an optical structure layer including an image display portion and a scattering portion that are integrally connected; and forming a reflection layer and a light-shielding layer. The reflection layer is disposed on the scattering portion opposite to the image display portion. The light-shielding layer is disposed on the reflection layer opposite to the image display portion.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a conventional projection screen.

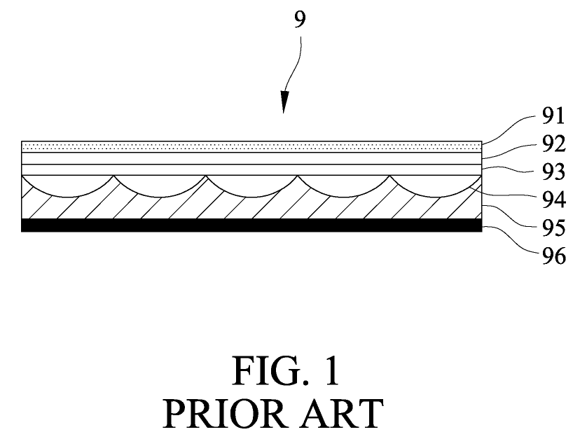

FIG. 2 is a perspective exploded view illustrating an embodiment of a projection screen of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

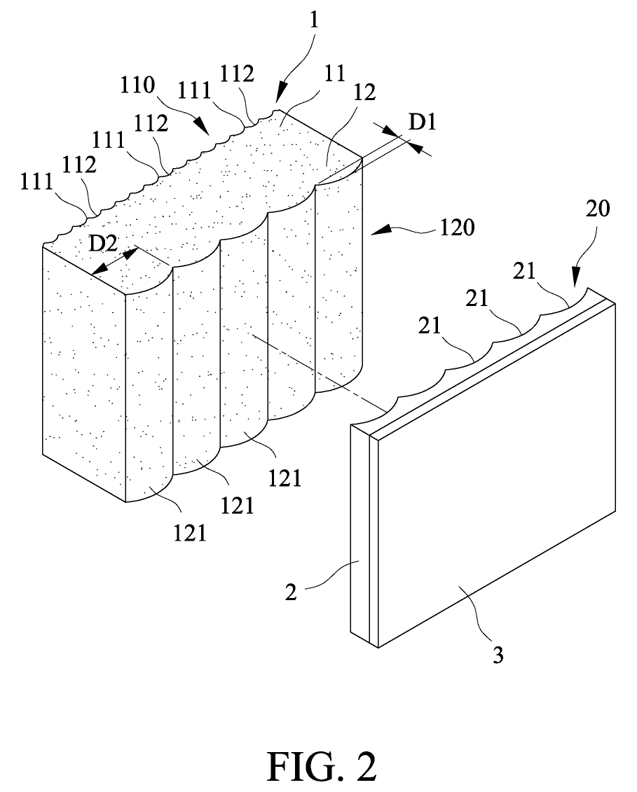

Referring to FIG. 2, an embodiment of a projection screen of the present disclosure includes an optical structure layer 1, a reflection layer 2, and a light-shielding layer 3. The optical structure layer 1 includes an image display portion 11 and a scattering portion 12 that are integrally connected. The reflection layer 2 is disposed on one side of the scattering portion 12 that is opposite to the image display portion 11. The light-shielding layer 3 is disposed on one side of the reflection layer 2 that is opposite to the scattering portion 12.

In some embodiments, the image display portion 11 has a surface 110 opposite to the scattering portion 12. The surface 110 is uneven and has protrusion regions 111 and recess regions 112 that alternate with each other, so that light projected on the surface 110 of the image display portion 11 may be diffusely scattered (e.g., diffuse reflection), and thus the projection screen may exhibit an anti-glare ability. The configuration(s) (e.g., the shape, the extent of convexity, etc.) of the protrusion regions 111 may be the same or may differ from one another. The configuration(s) (e.g., shape, the extent of concavity) of the recess regions 112 may be the same or may differ from one another. Through the presence of the protrusion regions 111 and the recess regions 112, the optical structure layer 1 may have a transmittance that ranges from 10% to 80%, a haze value that ranges from 40% to 70%, and a surface gloss value that is less than 30 GU as measured at 60degrees.

In some embodiments, the scattering portion 12 has a surface 120 opposite to the image display portion 11. The surface 120 has protruding structures 121 that are juxtaposed with each other and that protrude toward the reflection layer 2. The scattering portion 12 is connected to a surface 20 of the reflection layer 2. The surface 20 has recess structures 21 that correspond in shape to the protruding structures 121. With the protruding structures 121 of the scattering portion 12 and the recess structures 21 of the reflection layer 2, diffuse reflection may occur when the light propagates through the optical structure layer 1 and hits an interface between the reflection layer 2 and the scattering portion 12. Thus, the projection screen may have a broader angle of view. For example, the projection screen of the present disclosure may have an angle of view larger than 170 degrees. The configuration(s) of the protruding structures 121 are not limited as long as the diffuse reflection occurs. In some embodiments, each of the protruding structures 121 is strip-shaped, and has a convex surface and a cross-sectional shape resembling a segment of a circle. In certain embodiments, each of the protruding structures 121 has a chord height D1 that ranges from 5 µm to 25 µm, and a chord length D2 that is larger than 30 µm.

In some embodiments, each of the image display portion 11 and the scattering portion 12 (i.e., the optical structure layer 1) may include thermoplastic polyurethane (TPU). In some other embodiments, each of the image display portion 11 and the scattering portion 12 (i.e., the optical structure layer 1) may include thermoplastic polyurethane and a carbon black material that is dispersed in the thermoplastic polyurethane. In some embodiments, based on a total weight of the optical structure layer 1, the carbon black material is in an amount not greater than 15 wt%. With the carbon black material, the optical structure layer 1 may absorb ambient light, so that the projection screen may have a greater contrast ratio. In some embodiments, the carbon black material may have an average particle size ranging from 0.1 µm to 100 µm.

In some embodiments, the reflection layer 2 includes light-reflection particles and light-extinction particles. The reflection layer 2 features a reflection ability and a light-scattering ability. The reflection ability of the reflection layer 2 may enable the projection screen to have a vertical half angle of view not less than 20 degrees. The light-scattering ability of the reflection layer 2 may enable the projection screen to have a wider angle of view. Material(s) and shape(s) of the light-reflection particles are not limited as long as the light-reflection particles have a desired reflection ability. In some embodiments, the light-reflection particles include silver particles, aluminum powders, mica plates, or combinations thereof. The light-reflection particles may have an average particle size ranging from, but not limited to, 3 µm to 20 µm. In some embodiments, the light-extinction particles include titanium dioxide particles, barium sulphate particles, silicon dioxide particles, or combinations thereof. The light-extinction particles may have an average particle size ranging from, but not limited to, 0.1 µm to 5 µm. In some embodiments, based on a total weight of the reflection layer 2, the light-extinction particles are present in an amount not greater than 10 wt%.

In some embodiments, the light-shielding layer 3 includes a polymer matrix and light-shielding particles that are dispersed in the polymer matrix. The light-shielding layer 3 prevents the ambient light from passing therethrough, so that the projection screen may provide a good visual experience for audiences. The light-shielding layer 3 may have a transmittance less than 10%, but is not limited thereto. In some embodiments, the light-shielding particles includes carbon black particles, titanium dioxide particles, barium sulfate particles, silicon dioxide particles, or combinations thereof. The light-shielding particles may have an average particle size ranging from, but not limited to, 0.05 µm to 30 µm.

In some embodiments, the optical structure layer 1 has a thickness that is larger than a total thickness of the reflection layer 2 and the light-shielding layer 3. For example, the optical structure layer 1 may have the thickness ranging from 125 µm to 500 µm; the reflection layer 2 may have a thickness ranging from 10 µm to 50 µm; and the light-shielding layer 3 may have a thickness ranging from 10 µm to 30 µm.

A method for manufacturing the embodiment of the projection screen includes step (A) and step (B).

Step (A) involves forming the optical structure layer 1 including the image display portion 11 and the scattering portion 12 that are integrally connected.

Step (B) involves forming the reflection layer 2 and the light-shielding layer 3. The reflection layer 2 is disposed on the one side of the scattering portion 12 that is opposite to the image display portion 11. The light-shielding layer 3 is disposed on the one side of the reflection layer 2 that is opposite to the image display portion 11.

Possible materials and configurations for each of the image display portion 11, the scattering portion 12, the reflection layer 2, and the light-shielding layer 3 are described above, and thus the details are omitted herein for the sake of brevity. In some embodiments, the image display portion 11 and the scattering portion 12 are integrally molded by, e.g., a compression molding process to form the optical structure layer 1. In some embodiments, the reflection layer 2 is formed by a spraying process, a roll coating process, a vapor deposition process, or a sputtering process. In some embodiments, the light-shielding layer 3 is formed by a spreading process, a spraying process, a curtain coating process, or a roll coating process.

It should be noted that the sequence for forming the optical structure layer 1, the reflection layer 2, and the light-shielding layer 3 may vary based on practical needs. For example, the reflection layer 2 may be firstly formed on the scattering portion 12 of the optical structure layer 1, followed by forming the light shielding layer 3 on the reflection layer 2.

In summary, by virtue of the particular design of the optical structure layer 1, which includes the image display portion 11 and the scattering portion 12 that are integrally connected, the image display portion 11 and the scattering portion 12 may not separate from each other, so the projection screen may have a longer lifetime. In addition, the protrusion regions 111 and the recess regions 112 of the image display portion 11 may enable the projection screen to exhibit a desired anti-glare ability. The protruding structures 121 may enable the projection screen to have a desired angle of view (e.g., larger than 170 degrees). Furthermore, the projection screen of the present disclosure is able to be used with a short-throw projector, a mid-to-long-throw projector, or a long-throw projector, and thus an object of the present disclosure can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A projection screen, comprising:
an optical structure layer including an image display portion and a scattering portion that are integrally connected;
a reflection layer disposed on said scattering portion opposite to said image display portion; and
a light-shielding layer disposed on said reflection layer opposite to said scattering portion.

2. The projection screen as claimed in claim 1, wherein said image display portion has a surface, which is opposite to said scattering portion and which has protrusion regions and recess regions that alternate with each other.

3. The projection screen as claimed in claim 1, wherein said scattering portion has a surface opposite to said image display portion and having protruding structures that are juxtaposed with each other and that protrude toward said reflection layer.

4. The projection screen as claimed in claim 3, wherein each of said protruding structures is strip-shaped, and has a convex surface and a cross sectional shape resembling a segment of a circle.

5. The projection screen as claimed in claim 4, wherein each of said protruding structures has a chord height that ranges from 5 µm to 25 µm and a chord length that is larger than 30 µm.

6. The projection screen as claimed in claim 1, wherein said optical structure layer has a thickness that is larger than a total thickness of said reflection layer and said light-shielding layer.

7. The projection screen as claimed in claim 6, wherein said optical structure layer has the thickness ranging from 125 µm to 500 µm, said reflection layer has a thickness ranging from 10 µm to 50 µm, and said light-shielding layer has a thickness ranging from 10 µm to 30 µm.

8. The projection screen as claimed in claim 1, wherein said optical structure layer has a thickness ranging from 125 µm to 500 µm, said reflection layer has a thickness ranging from 10 µm to 50 µm, and said shading layer has a thickness ranging from 10 µm to 30 µm.

9. The projection screen as claimed in claim 1, wherein said optical structure layer has a haze value ranging from 40% to 70%.

10. The projection screen as claimed in claim 1, wherein said optical structure layer includes thermoplastic polyurethane (TPU).

11. The projection screen as claimed in claim 10, wherein said optical structure layer further includes a carbon black material.

12. The projection screen as claimed in claim 11, wherein, based on a total weight of said optical structure layer, said carbon black material is in an amount less than 15 wt%.

13. The projection screen as claimed in claim 11, wherein said carbon black material has an average particle size ranging from 0.1 µm to 100 µm.

14. A method for manufacturing a projection screen, comprising:
forming an optical structure layer including an image display portion and a scattering portion that are integrally connected; and
forming a reflection layer and a light-shielding layer, the reflection layer being disposed on the scattering portion opposite to the image display portion, the light-shielding layer being disposed on the reflection layer opposite to the image display portion.

15. The method as claimed in claim 14, wherein the image display portion and the scattering portion are integrally molded via a compression molding process.

16. The method as claimed in claim 14, wherein the reflection layer is formed by a spraying process, a roll coating process, a vapor deposition process, or a sputtering process.

17. The method as claimed in claim 14, wherein the shading layer is formed by a spreading process, a spraying process, a curtain coating process, or a roll coating process.
